(19) United States
(12) Patent Application Publication
(10) Pub. No.: US 2012/0098317 A1
(43) Pub. Date: Apr. 26, 2012

(54) AUTOMOBILE SEAT

(76) Inventor: Hack-sung Kim, Hwasung-si (KR)

(21) Appl. No.: 13/379,102

(22) PCT Filed: Jun. 15, 2010
(86) PCT No.: PCT/KR2010/003819

§ 371 Date: Dec. 19, 2011

(30) Foreign Application Priority Data
Jun. 19, 2009 (KR) 20-2009-0007918
Dec. 24, 2009 (KR) 10-2009-0130630

(51) Int. Cl. B60N 2/46

(52) U.S. Cl. 297/411.29; 297/411.2; 297/411.3

(57) ABSTRACT

A vehicle seat is installed inside a vehicle such that an occupant can sit thereon. The vehicle seat includes a backrest which forms a part of the vehicle seat, the backrest being brought into contact with a back of the occupant when the occupant sits, and an armrest which is provided on a central portion of a region of the backrest that is adjacent to a door of the vehicle and extends inwards a predetermined length from the region of the backrest that is adjacent to the door of the vehicle along a surface of the backrest. The occupant is allowed to lean an arm on the armrest when erecting his/her body from the vehicle seat in order to get out. The armrest is provided in the backrest, so that the occupant can easily erect his/her body by leaning an arm on the armrest in order to get out.

### TECHNICAL FIELD

The present invention relates to a vehicle seat.

### BACKGROUND ART

A plurality of vehicle seats are provided inside vehicles such that occupants can sit thereon.

When an occupant who is seated on a vehicle seat intends to get out of a vehicle, the occupant has to erect his/her body. However, vehicle seats of the related art are not provided with a structure that the occupant can hold, or with which the occupant can support himself using his/her hand. So, there is a drawback in that it is inconvenient for the occupant to get out of the vehicle.

### DISCLOSURE

### Technical Problem

An object of the present invention is to provide a vehicle seat, which has a structure for helping an occupant easily erect his/her body on the seat.

Another object of the present invention is to provide a vehicle seat, in which a structure for helping an occupant easily erect his/her body on the seat is variably configured.

### Technical Solution

In an aspect of the present invention, a vehicle seat is provided inside a vehicle such that an occupant can sit thereon. The vehicle seat includes a backrest which forms a part of the vehicle seat, the backrest being brought into contact with a back of the occupant when the occupant sits; and an armrest which is provided on a central portion of a region of the backrest that is adjacent to a door of the vehicle and extends inwards a predetermined length from the region of the backrest that is adjacent to the door of the vehicle along a surface of the backrest, whereby the occupant is allowed to lean an arm on the armrest when erecting his/her body from the vehicle seat in order to get out.

In another aspect of the present invention, a vehicle seat is provided inside a vehicle such that an occupant sits thereon. The vehicle seat includes a backrest which forms a part of the vehicle seat, the backrest being brought into contact with a back of the occupant when the occupant sits; and an armrest-forming unit. The armrest-forming unit includes an armrest-forming member which is movable with respect to the backrest, the armrest-forming member extends inwards a predetermined length to a surface portion of the backrest with which a back of the occupant is brought into contact; a drive motor which performs forward or backward rotation; and a power transmission member which is capable of moving the armrest-forming member with respect to the backseat. The drive motor and the power transmission member move the armrest-forming member with respect to the backseat so that an armrest is formed on the backseat, whereby the occupant is allowed to lean at least a portion from an elbow to a wrist or an arm on the armrest when erecting his/her body from the vehicle seat in order to get out.

In a further aspect of the present invention, a vehicle seat which is provided inside a vehicle such that an occupant sits thereon. The vehicle seat includes a backrest which forms a part of the vehicle seat, the backrest being brought into contact with a back of the occupant when the occupant sits; and an armrest-forming coupling member. The armrest-forming coupling member includes a coupling member body which is detachably coupled to the backrest; and an armrest which is provided in the coupling member body and is coupled to the backrest, wherein the armrest is provided on a central portion of a region of the backrest that is adjacent to a door of the vehicle and extends inwards a predetermined length from the region of the backrest that is adjacent to the door of the vehicle along a surface of the backrest, whereby the occupant is allowed to lean an arm on the armrest when erecting his/her body from the vehicle seat in order to get out.

In further another aspect of the present invention, a vehicle seat which is provided inside a vehicle such that an occupant sits thereon. The vehicle seat includes a backrest which forms a part of the vehicle seat, wherein the backrest is brought into contact with a back of the occupant when the occupant sits; and an armrest which is provided on an edge of a front portion of the backrest that is adjacent to a door of the vehicle, with an upper end of the armrest being formed at a position that corresponds to a height of a central portion of the backrest, whereby the occupant is allowed to lean an arm on the armrest when erecting his/her body from the vehicle seat in order to get out.

### Advantageous Effects

In an aspect of the vehicle seat according to the present invention, the armrest is provided in the backrest, so that an occupant who is seated on the vehicle seat can erect his/her body by leaning an arm on the armrest when he/she attempts to erect his/her body from the vehicle seat, for example, in order to get out of the vehicle. Consequently, there is an effect in that the occupant can easily erect his/her body by leaning his/her arm on the armrest without the need to hold other portions of the vehicle.

In another aspect of the vehicle seat according to the present invention, the armrest-forming unit is provided, so that the vehicle seat may be switched between the state in which the armrest is provided and the state in which the armrest is not provided according to necessity; i.e. a variable armrest structure may be provided. Consequently, the armrest may be provided to the vehicle seat only when it is necessary, for example, when the occupant attempts to get out, thereby improving the convenience of the vehicle seat.

In a further aspect of the vehicle seat according to the present invention, the armrest-forming coupling member is detachably coupled to the backrest of the vehicle seat. Consequently, there is an effect in that it is possible to easily provide the armrest to the backrest. It is still possible to easily remove the armrest from the backrest by detaching the armrest-forming coupling member when the armrest is not necessary, or when it is required to be replaced.

### DESCRIPTION OF DRAWINGS

FIG. 1 is a perspective view showing a vehicle seat according to a first embodiment of the present invention;

FIG. 2 is a perspective view showing a vehicle seat according to a second embodiment of the present invention;

FIG. 3 is a perspective view showing a vehicle seat according to a third embodiment of the present invention;

FIG. 4 is a cross-sectional view showing the armrest-forming unit of the vehicle seat according to the third embodiment of the present invention;

FIG. 5 is a cross-sectional view showing the armrest that is formed in response to the operation of the armrest-forming unit shown in FIG. 4;

FIG. 6 is a cross-sectional view showing a vehicle seat according to a fourth embodiment of the present invention, which is provided with an armrest-forming unit;

FIG. 7 is a cross-sectional view showing the armrest that is formed in response to the operation of the armrest-forming unit shown in FIG. 6;

FIG. 8 is an exploded perspective view showing a vehicle seat according to a fifth embodiment of the present invention, with an armrest-forming coupling member being disassembled therefrom;

FIG. 9 is an exploded perspective view showing a vehicle seat according to a sixth embodiment of the present invention, with an armrest-forming coupling member being disassembled therefrom;

FIG. 10 is an exploded perspective view showing a vehicle seat according to a seventh embodiment of the present invention, with an armrest-forming coupling member being disassembled therefrom; and

FIG. 11 is a perspective view showing a vehicle seat according to an eighth embodiment of the present invention, which has an armrest.

### BEST MODE

Hereinafter embodiments of a vehicle seat according to the present invention will be described with reference to the accompanying drawings.

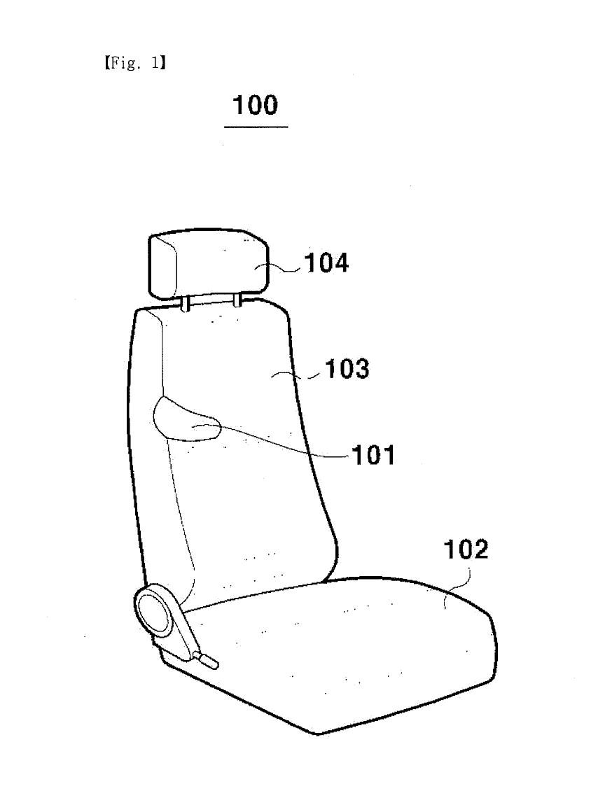

FIG. 1 is a perspective view showing a vehicle seat according to a first embodiment of the present invention.

Referring to FIG. 1, the vehicle seat 100 of this embodiment includes a seat section 102, a backrest 103 and a headrest 104, and is installed inside a vehicle such that an occupant can sit thereon.

The seat section 102 is a portion on which the buttocks of an occupant are placed when the occupant sits on the vehicle seat 100.

The backrest 103 is a portion with which the back of the occupant comes into contact when he/she sits on the seat 100.

The headrest 104 is a portion with which the head of the occupant comes into contact when he/she sits on the seat 100.

In this embodiment, the backrest 103 has defined therein an armrest recess 101.

The armrest recess 101 is configured such that it is depressed a predetermined length from the surface of the backrest 103. The armrest recess 101 is formed by a depression at a predetermined height such that it is substantially in the middle of the backrest 103 of the vehicle seat 100, i.e. the height of the elbow of the occupant on the vehicle seat 100, and extends inwards a predetermined length along the surface the backrest 103, from the side portion of the backrest that is adjacent to a vehicle door (not shown) to the portion of the surface of the backrest 103 with which the back of the occupant is brought substantially into contact. The armrest recess 101 is configured such that it is bent at a predetermined curvature. The armrest recess 101 may be inclined such that one portion thereof, which is adjacent to a door of the vehicle with respect to the seat section 102, is higher than another portion thereof.

As the armrest recess 101 is formed in the backrest 103 as described above, when the occupant on the vehicle seat 100 attempts to erect his/her body from the vehicle seat 100, for example, in order to get out of the vehicle, the occupant can erect his/her body by leaning an arm, particularly, at least a portion of the body part from the elbow to the wrist, or a hand on the armrest recess 101. Therefore, the occupant can easily erect the body from the vehicle seat 100 by leaning the arm on the armrest recess 101 without the need to hold another portion of the vehicle.

Here, the armrest recess 101 serves to help the occupant on the vehicle seat 100 to erect the body with his/her arm leaning on the vehicle seat 100 when he/she erects his/her body from the vehicle seat, and may be defined as an armrest.

### MODE FOR INVENTION

Descriptions will be given below of the other embodiments of the present invention with reference to the accompanying drawings. In the following descriptions, descriptions of some features will be omitted, since they are identical to those of the above-described first embodiment of the present invention.

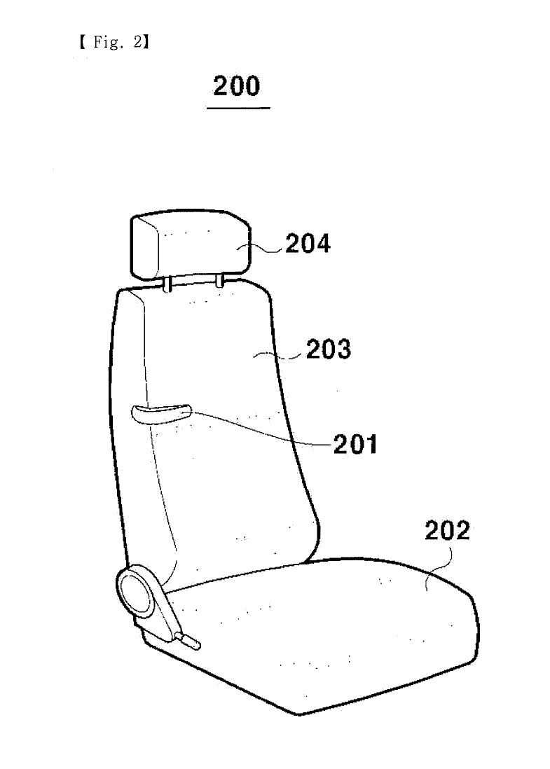

FIG. 2 is a perspective view showing a vehicle seat according to a second embodiment of the present invention.

Referring to FIG. 2, the vehicle seat 200 of this embodiment includes a seat section 202, a backrest 203 and a headrest 204.

In this embodiment, an armrest protrusion 201 is formed on the backrest 203.

The armrest protrusion 201 is configured such that it protrudes a predetermined length from the surface of the backrest 203. The armrest protrusion 201 is formed by a protrusion at a predetermined height such that it is substantially in the middle of the backrest 203 of the vehicle seat 200, i.e. the height of the elbow of the occupant on the vehicle seat 200, and extends inwards a predetermined length along the portion of the surface of the backrest 203, from the side portion of the backrest that is adjacent to a vehicle door (not shown) to the portion of the surface of the backrest 203 with which the back of the occupant is brought substantially into contact. The armrest protrusion 201 is configured such that it is bent at a predetermined curvature. The armrest protrusion 201 may be inclined such that one portion thereof, which is adjacent to a door of the vehicle with respect to the seat section 202, is higher than another portion thereof.

As the armrest protrusion 201 is formed in the backrest 203 as described above, when the occupant on the vehicle seat 200 attempts to erect his/her body from the vehicle seat 200, for example, in order to get out of the vehicle, the occupant can erect his/her body by leaning an arm, particularly, at least a portion of the body part from an elbow to a wrist, or a hand on the armrest protrusion 201. Therefore, the occupant can easily erect the body from the vehicle seat 200 by leaning the arm on the armrest protrusion 201 without the need to hold another portion of the vehicle.

Here, the armrest protrusion 201 serves to help the occupant on the vehicle seat 200 to erect his/her body with his/her arm leaning on the vehicle seat 200 when he/she erects his/her body from the vehicle seat, and may be defined as an armrest.

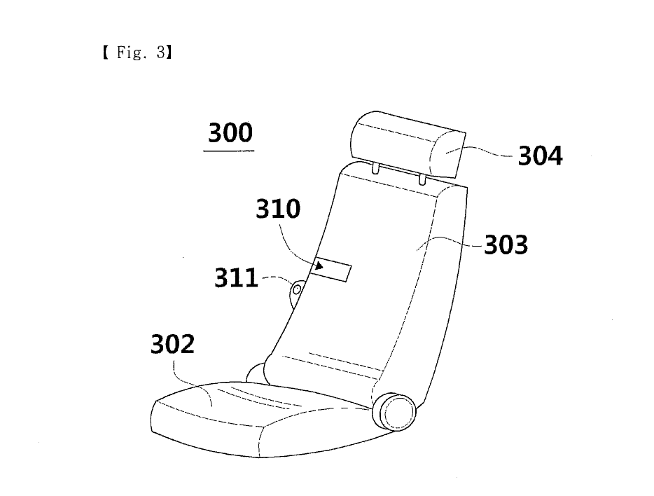

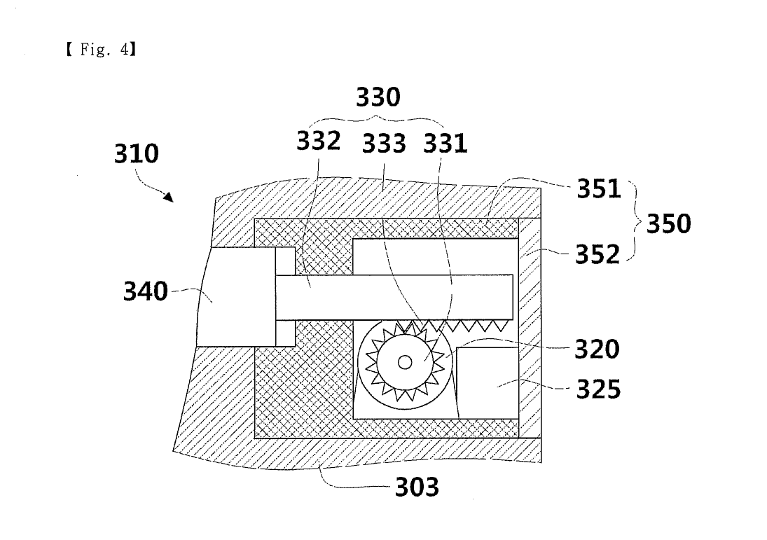

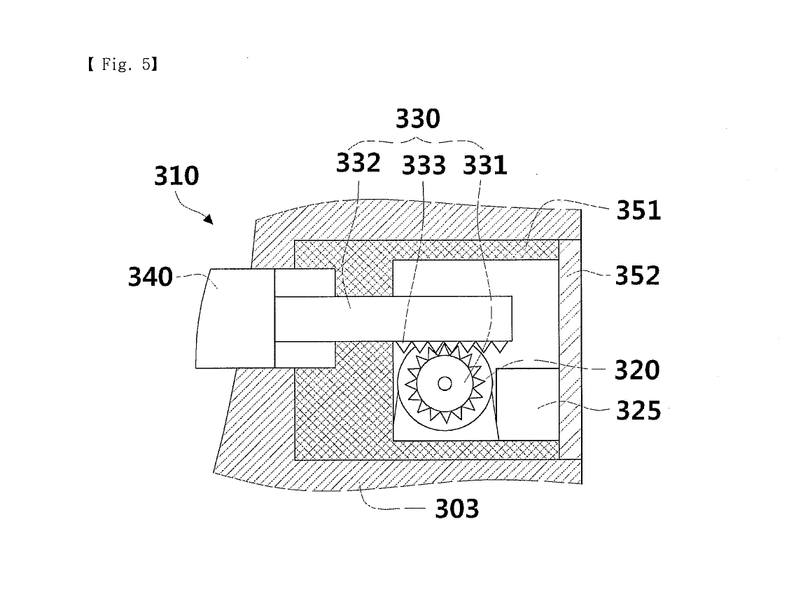

FIG. 3 is a perspective view showing a vehicle seat according to a third embodiment of the present invention, FIG. 4 is a cross-sectional view showing the armrest-forming unit of the vehicle seat according to the third embodiment of the present invention, and FIG. 5 is a cross-sectional view showing the armrest that is formed in response to the operation of the armrest-forming unit shown in FIG. 4.

Referring to FIG. 3 to FIG. 5, an armrest-forming unit 310 is provided in a backrest 303 of the vehicle seat 300 according to this embodiment.

Reference numeral 311 indicates an operating section such as an operating button. When an occupant pushes the operating button, the armrest-forming unit 310 operates to form the armrest. A description will be given below of the operation and structure of the armrest-forming unit.

The armrest-forming unit 310 includes a drive motor 320, a power supply 325, a power transmission member 330, an armrest-forming member 340 and a unit case 350.

The power supply 325 serves to supply power to the drive motor 320, and may be implemented as a rechargeable battery. Although the power supply 325 is illustrated as being formed inside the armrest-forming unit 310, this is for illustrative purposes only. The power supply 325 may not be separately provided; instead, the battery (not shown) of the vehicle in which the vehicle seat 300 is installed may be connected to the drive motor 320.

The drive motor 320 can operate when electric energy is supplied from the power supply 325. The operating section 311 is electrically connected to the drive motor 320, so that when the occupant pushes the operating section 311, the drive motor 320 is operated. The drive motor 320 may be implemented as a stepping motor that can rotate forward (counterclockwise with respect to the direction shown in FIG. 4 and FIG. 5, the same hereinafter) or backward (clockwise with respect to the direction shown in FIG. 4 and FIG. 5, the same hereinafter) to a predetermined angle whenever an operation signal is applied from the operating section 311.

The operating section 311 may be installed in a seat next to the driver's seat or a rear seat so that the occupant of each seat in which the operating section 311 is installed can directly operate the drive motor that is installed in the seat on which he/she is seated, or in the driver's seat, so that the driver can remotely operate the drive motor of the seat next to the driver's seat or the rear seat.

The power transmission member 330 drives the armrest-forming member 340 to move forwards or backwards in response to the rotation of the drive motor 320.

In this embodiment, the power transmission member 330 includes, in an example, a pinion 331, which is connected to the rotary shaft of the drive motor 320, and a rack 332, which has gear teeth 333 that engage with the gear teeth of the pinion 331. The armrest-forming member 340 is fixed to the front end of the rack 332, and in response to the motion, i.e. the forward or backward motion, of the rack 332, the armrest-forming member 340 also moves in the same direction.

The armrest-forming member 340 is contained in a recess, which is formed in the backrest 303, and is fixed to the rack 332, such that it can move with respect to the backrest 303 in response to the motion of the rack 332.

As in the foregoing embodiments, the armrest-forming member 340 is formed at a height such that it is substantially in the middle of the backrest 303 of the vehicle seat 300, i.e. the height of the elbow of the occupant on the vehicle seat 300, and extends inwards a predetermined length along the surface of the backrest 303, from the side portion of the backrest that is adjacent to a vehicle door (not shown) to the portion of the surface of the backrest 303 with which the back of the occupant is brought substantially into contact.

When the occupant does not need the armrest, the armrest-forming member 340 can be retracted into the recess, which is formed in the backrest 303, until the exposed surface of the armrest-forming member 340 becomes coplanar with the surface of the backrest 303, as shown in FIG. 4, so that the armrest-forming member 340 does not press the back of the occupant.

In contrast, when the occupant needs the armrest, for example, in order to get out of the vehicle, the front portion of the armrest-forming member 340 protrudes from the recess of the backrest 303, as shown in FIG. 5, so that the occupant can erect his/her body by leaning an arm, particularly, at least a portion of the body from the elbow to the wrist, or a hand on the protruding front portion of the armrest-forming member 340.

Since the occupant can lean the arm on the protruding front portion of the armrest-forming member 340, the protruding front portion of the armrest-forming member 340 may be defined as an armrest.

The unit case 350 includes a case body 351 having a through-hole through which the rack 332 can move. The case body 351 contains therein the drive motor 320, the power supply 325 and the power transmission member 330. The unit case 350 also includes a cover 352, which closes the case body 352.

The front portion of the case body 312 is formed at a position that is spaced apart a predetermined length from the surface of the backrest 303 so that the case body 351 does not come into contact with the back of the occupant when the occupant leans on the backrest 303.

When the cover 352 is detached from the case body 352, a worker can access the drive motor 320, the power supply 325 and the power transmission member 330, which are contained inside the case body 352. This may facilitate the maintenance, replacement or the like of the drive motor 320, the power supply 325 and the power transmission member 330.

A description will be given of the operation of the armrest-forming unit 310.

First, in the state in which the armrest-forming member 340 is retracted into and contained in the recess of the backrest 303, as shown in FIG. 4, when the occupant manipulates the operating section 311 in order to get out, the drive motor 320 connected to the operating section 311 is operated to rotate the pinion 331 forwards so that the rack 332 engaged with the pinion 331 moves forwards, as shown in FIG. 5. In response to the forward movement of the rack 332, the armrest-forming member 340 also moves forwards, thereby forming an armrest on the vehicle seat 300.

When the operating section 311 is manipulated once again, the drive motor 320 is operated to rotate the pinion 331 backwards so that the rack 332 moves backwards. The armrest-forming member 340 then also moves backwards so that the armrest-forming member 340 is retracted into the recess of the backrest 303, as shown in FIG. 4.

Although it is illustrated that the drive motor 320 is operated to rotate the pinion 331 backwards only when the operating section 311 is manipulated again, this is not intended to be limiting. Rather, a timer or the like may be added to the operating section 311 such that the drive motor 320 can be automatically operated to rotate the pinion 331 backwards after a predetermined time period has elapsed since the drive motor 320 was operated to rotate the pinion 311 forwards in response to the initial manipulation of the operating section 311.

Since the armrest-forming unit 310 is configured as described above, the vehicle seat 300 may be switched between the state in which the armrest is provided, as shown in FIG. 5, and the state in which the armrest is not provided, as shown in FIG. 4; i.e. the structure of the armrest may be variably provided. Consequently, the armrest may be provided to the vehicle seat 300 only when it is necessary, for example, when the occupant attempts to get out, thereby improving the convenience of the vehicle seat 300.

A description will be given of an armrest-forming unit according to a forth embodiment of the present invention. In the following disclosure, some features will not be described, since they are identical to those of the armrest-forming unit of the third embodiment of the present invention.

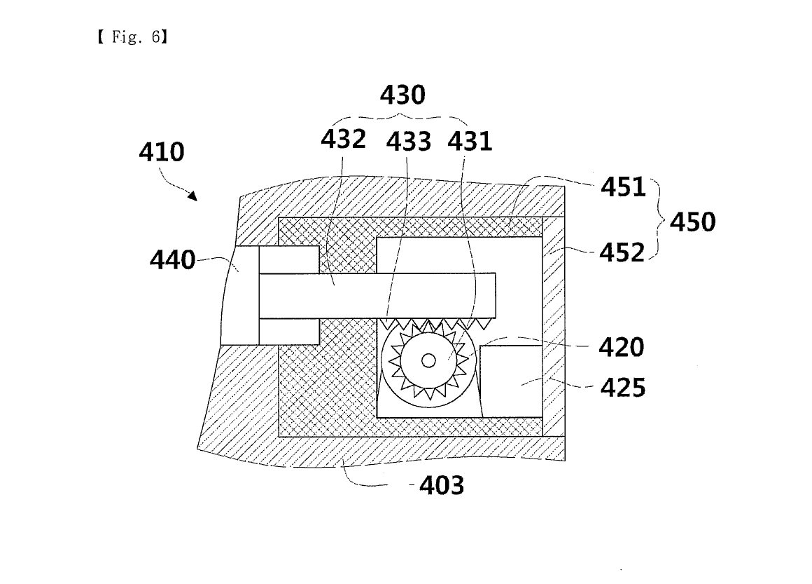

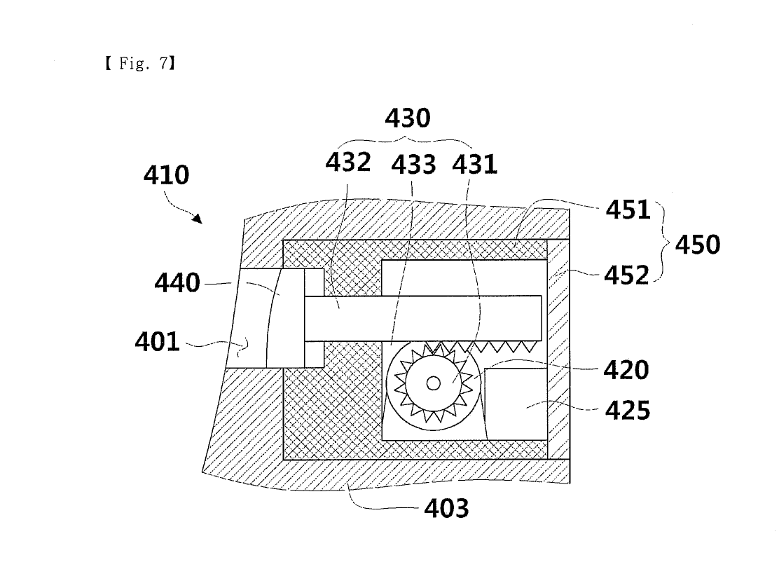

FIG. 6 is a cross-sectional view showing a vehicle seat according to a fourth embodiment of the present invention, which is provided with an armrest-forming unit, and FIG. 7 is a cross-sectional view showing the armrest that is formed in response to the operation of the armrest-forming unit shown in FIG. 6.

Referring to FIG. 6 and FIG. 7, in this embodiment, when a drive motor 420 is operated to rotate a pinion 431 backwards, a rack 432 is caused to move backwards so that an armrest-forming member 440 moves backwards, retracting into a backrest 403, as shown in FIG. 7. Consequently, a recess is formed in the portion of the backrest 403 that corresponds to the backward motion of the armrest-forming member 440. The recess then functions as an armrest.

In contrast, when the drive motor 420 is operated to rotate the pinion 431 forwards, the rack 432 is caused to more forwards so that the armrest-forming member 440 moves forwards, as shown in FIG. 6. The forward motion of the armrest-forming member 440 then removes the armrest.

As described above, the operation of the armrest-forming unit 410 of this embodiment can result in the recess-like armrest of the backrest 403.

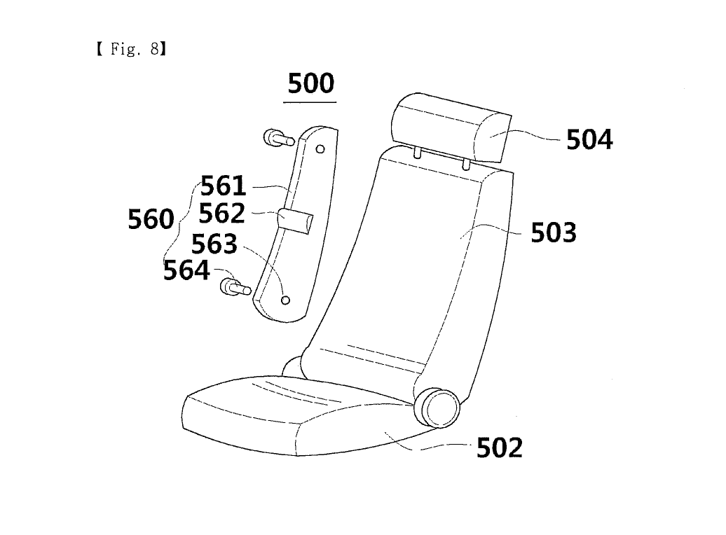

FIG. 8 is an exploded perspective view showing a vehicle seat according to a fifth embodiment of the present invention, with an armrest-forming coupling member being disassembled therefrom.

Referring to FIG. 8, the armrest-forming coupling member 560 is coupled to a side of a backrest 503 of a vehicle seat 500 such that an armrest 562 is formed on the backrest 503.

The armrest-forming coupling member 560 includes a coupling member body 561, an armrest 562, coupling-holes 563 and coupling means 564.

The coupling member body 561 is configured similar to the side such that it can be detachably coupled to the side of the backrest 503. In this embodiment, the length of the coupling member body 561 is set similar to that of the side of the backrest 503.

The armrest 562 is formed substantially on the central portion of the front surface of the coupling member body 561. When the coupling member body 561 is coupled to the side of the backrest 503, the armrest 562 is positioned on the central portion of the side of the backrest 503 that is adjacent to a vehicle door, and extends inwards a predetermined length from the side that is adjacent to the vehicle door along the surface of the backrest 503. Then, the occupant can erect his/her body by leaning an arm on the armrest 562 when he/she gets out.

The coupling-holes 563 are formed in the upper and lower portions of the coupling member body 561, such that the coupling means 563 such as bolts pass through the coupling-holes 563. The armrest-forming coupling member 560 can be coupled to the backrest 503 of the vehicle seat 500 when the coupling means 563 are engaged with the side of the backrest 503 through the coupling-holes 563.

The armrest-forming coupling member 560 can be separated from the backrest 503 by decoupling the coupling means 564.

Since the armrest-forming coupling member 560 is detachably coupled to the backrest 503 of the vehicle seat 500 as described above, it is possible to easily provide the armrest 562 to the backrest 503. It is still possible to easily remove the armrest 562 from the backrest 503 by detaching the armrest-forming coupling member 560 when the armrest 562 is not necessary, or when it is required to be replaced.

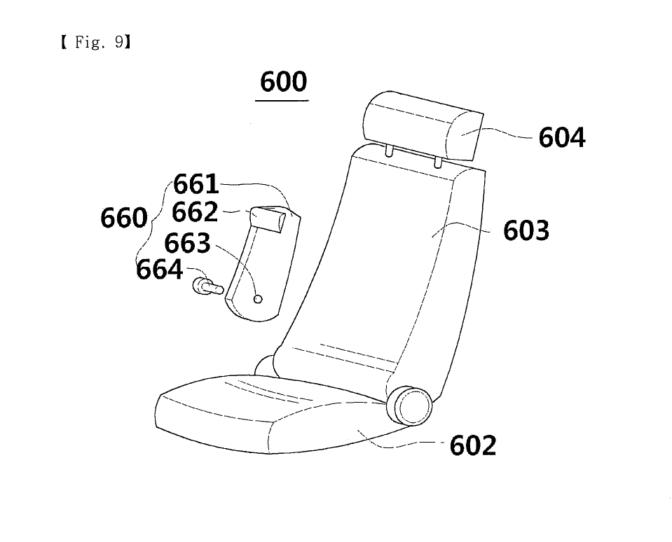

FIG. 9 is an exploded perspective view showing a vehicle seat according to a sixth embodiment of the present invention, with an armrest-forming coupling member being disassembled therefrom.

Referring to FIG. 9, in the armrest-forming coupling member 660 of this embodiment, the upper end of a coupling member body 661 extends to a position that corresponds to the upper end of an armrest 662, and the lower end of the coupling member body 661 extends to a position that corresponds to the lower portion of the backrest 603. Consequently, the coupling member body 661 is configured such that it extends from the upper end of to the lower end of the armrest 662, thereby providing a compact structure, which can be coupled to the backrest 603.

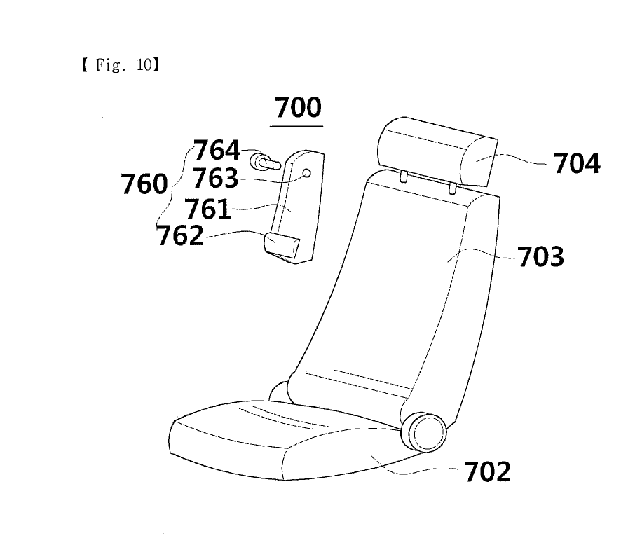

FIG. 10 is an exploded perspective view showing a vehicle seat according to a seventh embodiment of the present invention, with an armrest-forming coupling member being disassembled therefrom.

Referring to FIG. 10, in the armrest-forming coupling member 760 of this embodiment, the lower end of a coupling member body 761 extends to a position that corresponds to the lower end of an armrest 762, and the upper end of the coupling member body 761 extends to a position that corresponding to the upper portion of a backrest 703. Consequently, the coupling member body 761 is configured such that it extends from the lower end of to the upper end of the armrest 762, thereby providing a compact structure, which can be coupled to the backrest 703.

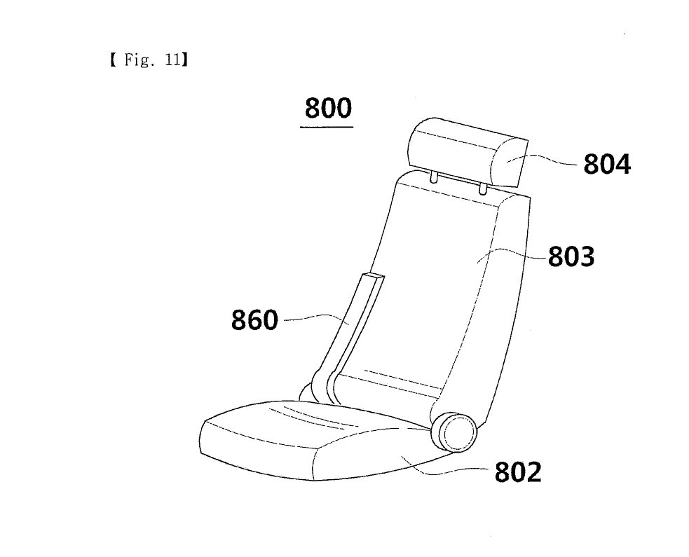

FIG. 11 is a perspective view showing a vehicle seat according to an eighth embodiment of the present invention, which has an armrest.

Referring to FIG. 11, in this embodiment, an armrest 860 is provided on the edge of the front surface of a backrest 803 of the vehicle seat 800 that is adjacent to a vehicle door.

The armrest 860 is configured such that it protrudes a predetermined length from the surface of the backrest 803, with the height of the upper end thereof being substantially in the middle of the backrest 803. An occupant can get out by leaning an arm on the upper end of the backrest 803.

The armrest 860 is shaped as a rod having a predetermined height, and can be provided on the edge of the front surface of the armrest 860 of the vehicle seat 800 that is adjacent to a vehicle door, from the lower end to the central portion of the armrest 860.

While the present invention has been shown and described with reference to certain exemplary embodiments thereof, it will be understood by those skilled in the art that various changes and variations may be made therein without departing from the spirit and scope of the present invention as defined by the appended claims and their equivalents. It should be understood, however, that all such changes and variations fall within the scope of the present invention.

### INDUSTRIAL APPLICABILITY

In an aspect of the vehicle seat according to the present invention, the occupant can easily erect his/her body from the vehicle seat in order to get out of the vehicle, and the structure for helping the occupant erect his/her body to get off is variably provided. Therefore, it is apparent that the present invention has prominent industrial applicability.

1. A vehicle seat which is provided inside a vehicle such that an occupant sits thereon, comprising:
a backrest which forms a part of the vehicle seat, wherein the backrest is brought into contact with a back of the occupant when the occupant sits; and
an armrest which is provided on a central portion of a region of the backrest that is adjacent to a door of the vehicle and extends inwards a predetermined length from the region of the backrest that is adjacent to the door of the vehicle along a surface of the backrest, whereby the occupant is allowed to lean an arm on the armrest when erecting his/her body from the vehicle seat in order to get out.

2. The vehicle seat of claim 1, wherein the armrest comprises an armrest recess which is depressed from the surface of the backrest, the armrest recess being inclined such that one portion thereof, which is adjacent to the door of the vehicle, is higher than another portion thereof.

3. The vehicle seat of claim 1, wherein the armrest comprises an armrest protrusion which protrudes from the surface of the backrest, the armrest protrusion being inclined such that one portion thereof, which is adjacent to the door of the vehicle, is higher than another portion thereof.

4. A vehicle seat which is provided inside a vehicle such that an occupant sits thereon, comprising:
a backrest which forms a part of the vehicle seat, wherein the backrest is brought into contact with a back of the occupant when the occupant sits; and
an armrest-forming unit, wherein the armrest-forming unit comprises:
an armrest-forming member which is movable with respect to the backrest, the armrest-forming member extends inwards a predetermined length to a surface portion of the backrest with which a back of the occupant is brought into contact;
a drive motor which performs forward or backward rotation; and
a power transmission member which is capable of moving the armrest-forming member with respect to the backseat,
wherein the drive motor and the power transmission member move the armrest-forming member with respect to the backseat so that an armrest is formed on the backseat, whereby the occupant is allowed to lean at least a portion from an elbow to a wrist or an arm on the armrest when erecting his/her body from the vehicle seat in order to get out.

5. The vehicle seat of claim 4, wherein, when the armrest-forming member is moved so that the armrest-forming member protrudes from the backrest, a portion of the armrest-forming member that has protruded serves as the armrest.

6. The vehicle seat of claim 4, wherein, when the armrest-forming member is moved so that the armrest-forming member retracts into the backrest, a portion of the armrest-forming member that has retracted serves as the armrest.

7. A vehicle seat which is provided inside a vehicle such that an occupant sits thereon, comprising:
a backrest which forms a part of the vehicle seat, wherein the backrest is brought into contact with a back of the occupant when the occupant sits; and
an armrest-forming coupling member, wherein the armrest-forming coupling member comprises:
a coupling member body which is detachably coupled to the backrest; and
an armrest which is provided in the coupling member body and is coupled to the backrest, wherein the armrest is provided on a central portion of a region of the backrest that is adjacent to a door of the vehicle and extends inwards a predetermined length from the region of the backrest that is adjacent to the door of the vehicle along a surface of the backrest, whereby the occupant is allowed to lean an arm on the armrest when erecting his/her body from the vehicle seat in order to get out.

8. A vehicle seat which is provided inside a vehicle such that an occupant sits thereon, comprising:
a backrest which forms a part of the vehicle seat, wherein the backrest is brought into contact with a back of the occupant when the occupant sits; and
an armrest which is provided on an edge of a front portion of the backrest that is adjacent to a door of the vehicle, wherein an upper end of the armrest is formed at a position that corresponds to a height of a central portion of the backrest, whereby the occupant is allowed to lean an arm on the armrest when erecting his/her body from the vehicle seat in order to get out.
